(19) United States
(12) Patent Application Publication
(10) Pub. No.: US 2009/0210242 A1
(43) Pub. Date: Aug. 20, 2009

(54) LOAD BALANCE PAYMENT

(75) Inventors: Neil W. Black, Seattle, WA (US); Jeffrey D. Couckuyt, Bothell, WA (US); Ivan J. Tashev, Kirkland, WA (US); John C. Krumm, Redmond, WA (US); Ruston Panabaker, Redmond, WA (US); Michael Lewis Seltzer, Seattle, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/033,690

(22) Filed: Feb. 19, 2008

(51) Int. Cl. G06Q 99/00

(52) U.S. Cl. 705/1

(57) ABSTRACT

A user can be provided a variety of incentives to take a route that is different from a standard path in order to relieve path load balancing issues. Information on a primary path can be collected and analyzed to determine if it would be beneficial to encourage users to take an alternate path. If it is determined that users should be encouraged to take another path, then analysis of potential users can occur. A result of the user analysis can be used to select users that are offered to take the alternate path as well as an incentive offered to the user to encourage her to take the alternate path.

### TECHNICAL FIELD

The subject specification relates generally to route production and in particular to providing an incentive to a user to take a particular route

### BACKGROUND

Computer-driven route planning applications are utilized to aid users in locating points of interest, such as particular buildings, addresses, and the like. Additionally, in several existent commercial applications, users can vary a zoom level, thereby enabling variation of context and detail as a zoom level of a map is altered. For example, as a user zooms in on a particular location, details such as names of local roads, identification and location of police and fire stations, identification and location of public services, such as libraries, museums, and the like can be provided to the user. When zooming out, the user can glean information from the map such as location of the point of interest within a municipality, state/providence, and/or country, proximity of the point of interest to major freeways, proximity of the point of interest to a specific city, and the like.

Furthermore, conventional computer-implemented mapping applications often include route-planning applications that can be utilized to provide users with directions between different locations. Pursuant to an example, a user can provide a route planning application with a beginning point of travel and an end point of travel (e.g., beginning and ending addresses). The route planning application can include or utilize representations of roads and intersections and one or more algorithms to output a suggested route of travel. These algorithms can output routes depending upon user-selected parameters. For instance, a commercial route planning application can include a check box that enables a user to specify that she desires to avoid highways. Similarly, a user can inform the route planning application that she wishes to travel on a shortest route or a route that takes a least amount of time (as determined by underlying algorithms). Over the last several years, individuals have grown to rely increasingly on route planning applications to aid them in everything from locating a friend's house to planning cross-country road trips.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Conventionally, a user inputs data, such as an intended destination and travel constraints, into a route generation device and a route is produced based upon the data. As these devices become more prevalent, common logic can be used to produce a plurality of routes to different users (e.g., logic used by devices of a common manufacturer). Since similar logic can be used, paths can become congested due to heavy direction from route generation devices.

With the disclosed innovation, a user can be offered a reward to take an alternate route, thus alleviating congestion along a primary route. An evaluation component can analyze metadata related to a user, such as determining if a user is likely to accept a route diversion offer. Based upon a result of the analysis, a choice component can select a reward that is likely to motivate a driver to take a different route than one commonly used. Functionality can be added upon the innovation, such as running an auction between different businesses, where the businesses supply the reward to have the alternate route be one that passes by their store.

Encouraging a user to take a less efficient route is considered undesirable in conventional research circles. For instance, if a user asks for a route to be shortest in distance, then it would seem illogical and be against standard practice to attempt to have the user take a longer route. However, practice of the disclosed innovation allows the user to receive a reward and for other users to have a more enjoyable experience (e.g., more enjoyable than other users on a route with a high traffic load). Thus, unexpected benefits can be obtained by multiple parties and thus practice of the disclosed innovation can surprisingly overcome conventionally held concerns of those that research traffic routing.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative system for balancing traffic loads along a path in accordance with an aspect of the subject specification.

FIG. 2 illustrates a representative system for balancing traffic loads along a path with a detailed example evaluation component in accordance with an aspect of the subject specification.

FIG. 3 illustrates a representative system for balancing traffic loads along a path with a detailed example choice component in accordance with an aspect of the subject specification.

FIG. 4 illustrates a representative system for balancing traffic loads along a path with various additional components for enhanced functionality in accordance with an aspect of the subject specification.

FIG. 5 illustrates a representative system for balancing traffic loads along a path with various supplementary components for augmented functionality in accordance with an aspect of the subject specification.

FIG. 6 illustrates a representative methodology for supplying a route to a user that results as a function of traffic load balancing in accordance with an aspect of the subject specification.

FIG. 7 illustrates a representative methodology for conducting an auction to gain a reward to alter traffic load balance in accordance with an aspect of the subject specification.

FIG. 8 illustrates a representative methodology for checking users that can be diverted to change traffic load balancing in accordance with an aspect of the subject specification.

FIG. 9 illustrates an example of a schematic block diagram of a computing environment in accordance with an aspect subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

As used herein, the terms to “infer” or “inference” refer generally to the process of reasoning about or deducing states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. It is to be appreciated that determinations or inferences referenced throughout the subject specification can be practiced through use of artificial intelligence techniques.

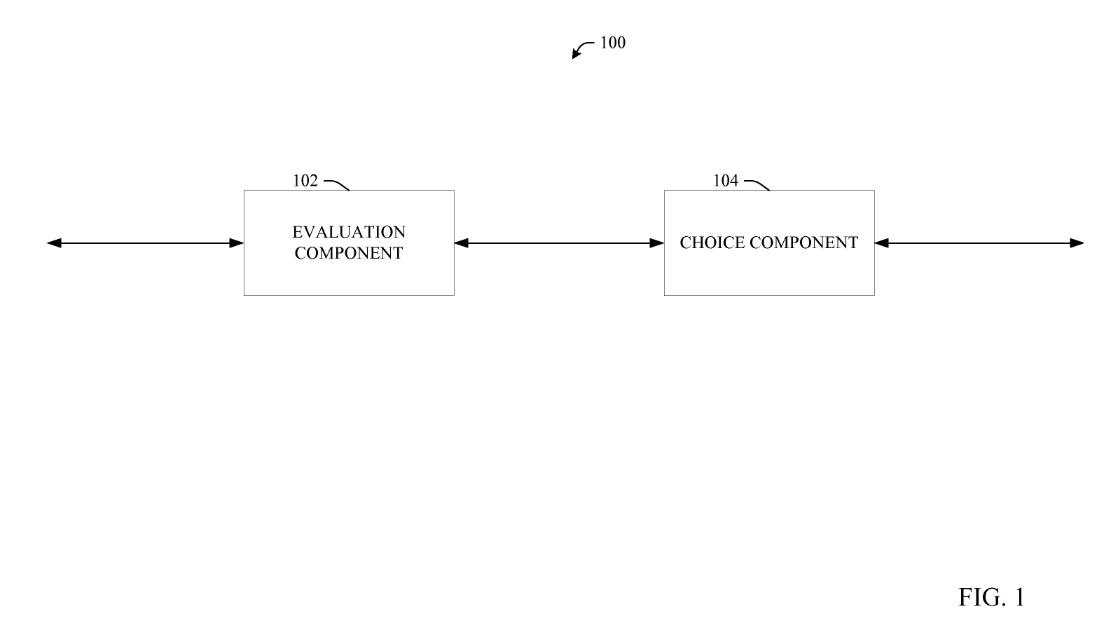

Now referring to FIG. 1, an example system 100 is disclosed for offering a reward to a user for taking a particular route often to alleviate a high traffic load on another route. As traffic routing systems become more abundant, these systems can influence traffic loads along various routes. For instance, a baseball game can take place in a large metropolitan area, where there is one main highway leading individuals out of the area. When the game ends, it can be presumed, observed, etc. that many route generation systems instruct users to take the highway to exit the area. Since the route generation systems are acting in a similar manner, it is quite possible for the highway to become congested due to analogous routes being produced. The disclosed innovation enables for traffic load balancing to be performed through offering a user a reward to take a non-standard route.

Data that pertains to a user can be collected by an evaluation component 102 that analyzes metadata related to the user. A user can input an intended destination and a global positioning system can determine a user starting location. A route can be initially generated using conventional means and evaluated to determine if there is a load balance problem upon the route (e.g., traffic is heavy along the route). A check can be performed upon the user to determine if she is likely to accept a reward to change her route to assist in alleviating the heavy load on the route. For instance, the evaluation component 102 can retain a user profile in storage, and make a determination of likelihood based upon user history. In addition, contextual information can be taken into account in analysis of the user. For instance, the system 100 can infer that a user traveling to an airport to take a flight is less likely to take a different route than a user on a leisurely drive.

At least a portion of an analysis result can be accessed by a choice component 104 that selects a reward to motivate the user to avoid a path with a high traffic load, the selection is based upon a result of the analysis. For example, there can be a determination based upon the analysis that the user is saving money for a vacation cruise. The choice component 104 can contact different cruise companies requesting a reward, such as the system 100 offering about $1 for an about $2 coupon towards a cruise. Since the user is presumed to be more likely to take the cruise line with the coupon, the cruise line is given a benefit. According to one embodiment, the system 100 can be credited about $1.50 by a government organization for having the user take the different route. The government organization can gain benefits such as having less congestion in case of emergency (e.g., an ambulance needs to travel down the route), less wear along a road, savings from building new roads or extending existing ones since peak traffic will be spread to alternative roads, increased safety due to decreased congestion, and the like.

While the subject specification discusses altering paths of a user route to change load balancing, it is to be appreciated that other configurations can be practiced, such as offering a reward for a user to leave at a different time. For example, a route can have heavy traffic during what is known as morning rush hour, commonly between 8AM to 9AM. If a municipality desires to alleviate congestion during rush hour, the system 100 can identify users that have flexible scheduling (e.g., have a job that does not require him to be at work at 9AM) and offer a reward to at least a portion of the users to leave at a later time of a day after 9AM. In addition, rewards can stretch over a period—in an illustrative instance, a user can be provided a reward for leaving after 9AM for a week, for a month, etc.

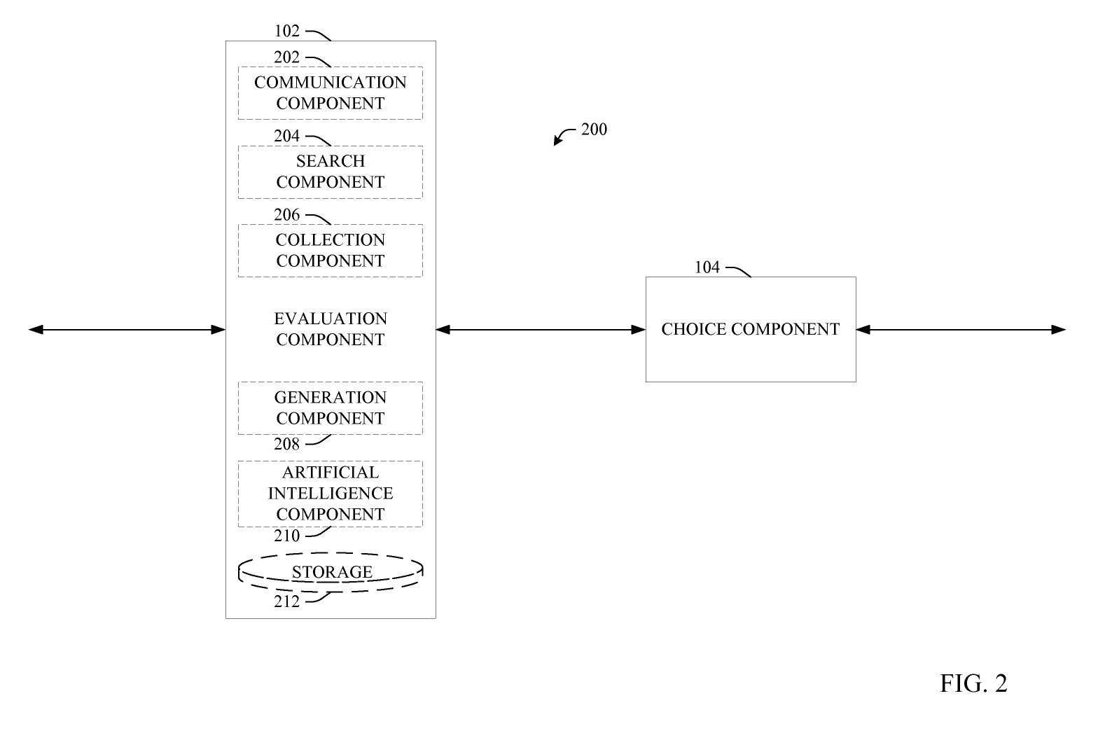

Now referring to FIG. 2, an example system 200 is disclosed for offering a reward to a user for taking a particular route often to alleviate a high traffic load on another route with a detailed evaluation component 102. The evaluation component 102 can analyze metadata related to a user, including user history based upon a personal profile, user contextual information, and the like. A communication component 202 can engage with other devices to transfer information, such as to send a request for information, receiving information from an auxiliary source, etc. Operation can take place wirelessly, in a hard-wired manner, employment of security technology (e.g., encryption), etc. Information transfer can be active (e.g., query/response) or passive (e.g., monitoring of public communication signals). Moreover, the communication component 202 can utilize various protective features, such as performing a virus scan on collected data and blocking information that is positive for a virus.

A search component 204 can locate at least one source of metadata related to the user's route. According to one embodiment, the search component 204 can monitor open airwaves to determine if data can be extracted, such as traffic reports of a radio broadcast. In addition, the search component 204 can retain a database of reliable sources and continuously update the database as reliability information is gathered.

A collection component 206 can obtain metadata related to the user's route, oftentimes from at least one source located by the search component 204. Analysis can be performed upon the data, where a result of the analysis is used to make various determinations, such as if a user is likely to accept a reward offer, a reward to offer the user, and so forth. It is possible that such a large amount of information can be gathered that it can be beneficial for filtering to take place. The collection component 206 can filter out obtained data that is not from select sources (e.g., reliable sources), blocking data determined irrelevant from other components, as well as other filtering configurations.

A generation component 208 can construct a route or several alternative routes, oftentimes the routes that are constructed are modified to include a path associated with a reward (e.g., a path without a load balancing problem). The generation component 208 can access a mapping database and determine paths that should be combined to create a direction set. Various features can integrate with the generation component 208 to enhance functionality—for instance, the generation component 208 can predict an intended destination of a user (e.g., through practice of artificial intelligence techniques) and create a route to the predicted intended destination.

Various components disclosed in the subject specification can utilize an artificial intelligence component 210 that makes at least one determination or at least one inference in regard to the metadata analysis or reward selection. For instance, the artificial intelligence component 210 can be used to determine when a route would benefit from load balancing. The artificial intelligence component 210 can be used to make various inferences, such as if a user would likely follow a reward based upon contextual data.

The artificial intelligence component 210 can employ one of numerous methodologies for learning from data and then drawing inferences and/or making determinations related to applying a service (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. Methods also include methods for the capture of logical relationships such as theorem provers or more heuristic rule-based expert systems.

Different pieces of information, such as collected materials, component operating instructions (e.g., of the generation component 208), source location, the profile maintained by the summary component 206, etc. can be held on storage 212. Storage 212 can arrange in a number of different configurations, including as random access memory, battery-backed memory, hard disk, magnetic tape, etc. Various features can be implemented upon storage 212, such as compression and automatic back up (e.g., use of a Redundant Array of Independent Drives configuration). A choice component 104 can select a reward to motivate the user to avoid a path with a high traffic load (e.g., a conduit can have a small number of vehicles, but an accident is causing the vehicles to move slowly), the selection is based upon a result of the analysis.

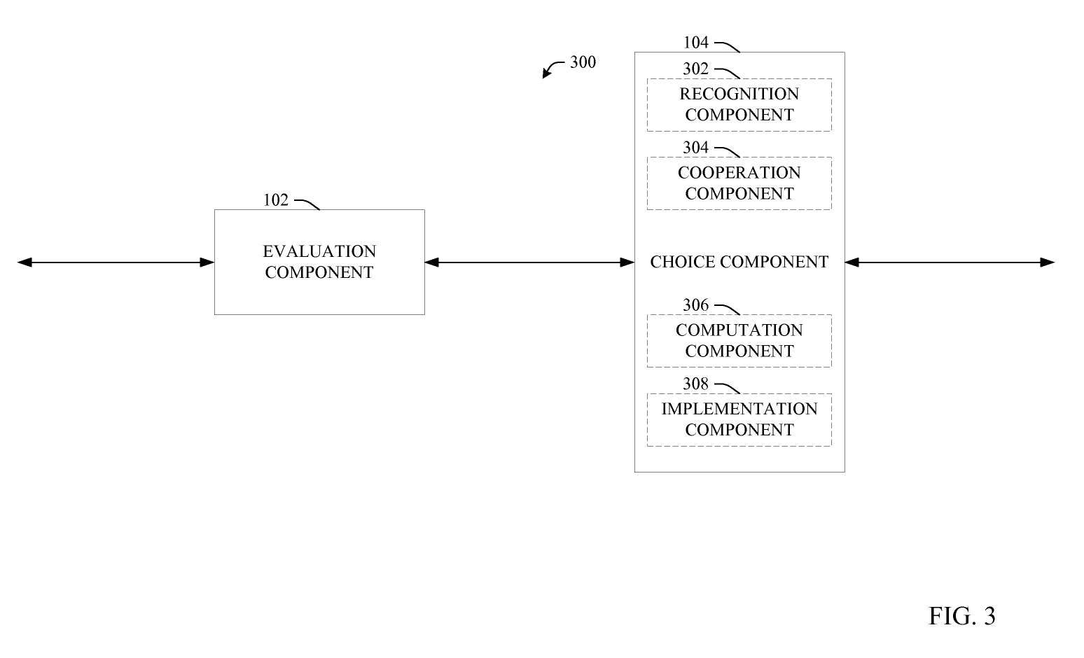

Now referring to FIG. 3, an example system 300 is disclosed for offering a reward to a user for taking a particular route often to alleviate a high traffic load on another route with a detailed choice component 104. An evaluation component 102 can analyze metadata related to a user and allow the choice component 104 to access the metadata as well as a result of the analysis. The choice component 104 can select a reward to motivate the user to avoid a path with a high traffic load (e.g., a relatively high load, one or more vehicles, etc.); the selection is based upon a result of the analysis.

A recognition component 302 can identify a path with the high traffic load. The collection component 206 of FIG. 2 can gather data on traffic for different paths and the recognition component 302 can determine that a path included on a route produced by the generation component 208 of FIG. 2 has a high traffic load. In addition, the recognition component 302 can perform analysis upon other possible paths to determine if other paths have a high traffic load. Analysis of other paths can be used to determine if a reward offer should be made (e.g., there are no reasonable roads with a low traffic load, than no reward is made), if an addition of the user on another path is likely to cause the path to be considered in a high traffic load state by other devices, and the like.

A cooperation component 304 can enter a negotiation with at least one entity where the entity supplies the reward. Different entities can desire to offer a reward to a user to take a different route—municipalities can attempt to please residents by filtering traffic to major streets, businesses can desire to have vehicles pass their advertisements, and so forth. The cooperation component 304 can send bid offers to different entities to supply a reward. This can be a static negotiation (e.g., a simple request to the entity) as well as a dynamic negotiation (e.g., notifying a bidding business of other bids and offering the bidding business to supply a higher bid).

A computation component 306 can calculate a selected reward. According to one embodiment, the computation component aggregates rewards associated for different alternate routes. For instance, ‘Route A’ can have a municipality offering about $1 and a business offering about $1 while ‘Route B’ has a business offering about $1.50. The computation component 306 can determine that a user can receive a higher reward if she takes ‘Route A’ over ‘Route B’ and the higher reward can be used to determine a route for selection. Calculations can be relatively simple, such as determining a reward that is offering a highest value. However, calculations that are more complex can be performed, such as predicting likelihood of a user taking an action base upon a reward. Additional factors can be considered such as the user's schedule (e.g., ‘Route B’ is shorter, using ‘Route A’ will make her late for meeting or appointment), cost of the fuel (e.g., it can be of little value for a user to receive an about $1.5 reward by using about $2 worth of fuel), estimated cost of users time, etc.

An implementation component 308 can implement actions consistent with linking the reward to the route. For instance, computer code can be written by the implementation component 308 such that the reward and route connect. However, other configurations can be practiced, such as notifying at least one unit that observes driver operations that a reward is to be associated with an action and a signal should be sent when/if the driver performs the action (e.g., the user travels upon an alternate route). While the subject specification discusses overtly instructing that a lesser route is taken, it is to be appreciated that aspects can be practiced without knowledge of the user (e.g., a user is automatically diverted to another route to alleviate traffic load balancing with or without being provided a reward) or that the route not actually be a lesser route.

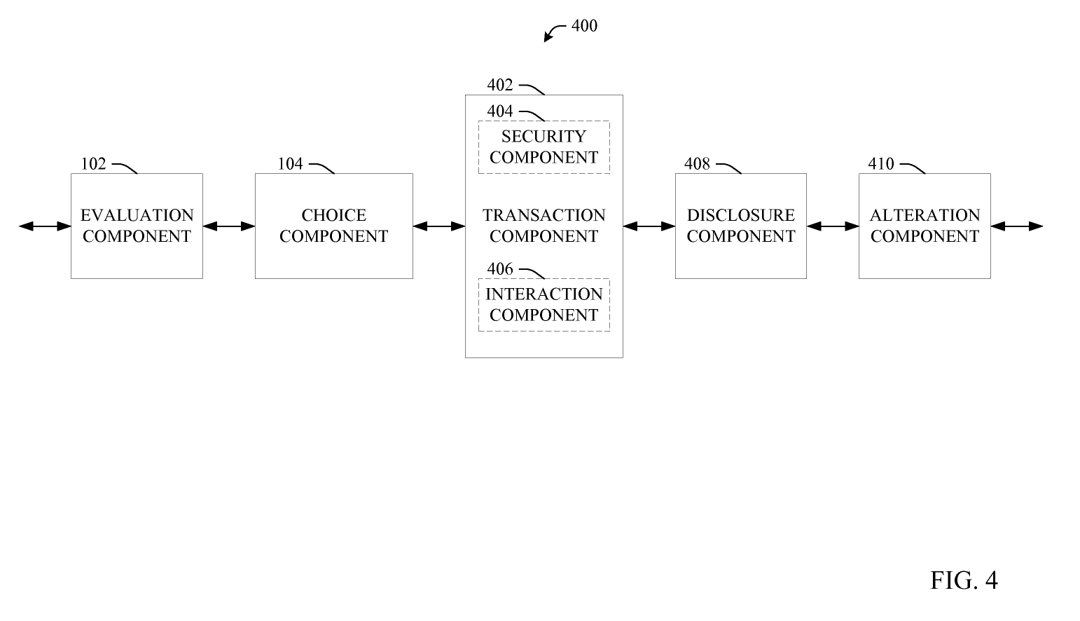

Now referring to FIG. 4, an example system 400 is disclosed for offering a reward to a user for taking a particular route often to alleviate a high traffic load on another route with various additional components that can enhance functionality. An evaluation component 102 can analyze metadata related to a user and allow a choice component 104 to access the metadata as well as a result of the analysis. The choice component 104 can select a reward to motivate the user to avoid a path with a high traffic load where the selection is based upon a result of the analysis.

A transaction component 402 can perform a financial operation in regard to the selected reward. The transaction component 402 can perform actions to meet constraints, such as debiting a user account and crediting a provider account. While fiscal amounts are commonly transacted, it is to be appreciated that other commodities can be exchanged, such as coupons, meeting of contractual obligations (e.g., canceling of a task to be performed), tax credits, etc.

Moreover, a financial operation can take place in relation to user response to a commercial detail (e.g., advertisement along an alternate route). For example, an advertisement can be displayed that a user should stop at a highway exit for a cup of coffee. If the user takes the exit, buys the cup of coffee, buys a different item, etc., then payments of varying amounts can be made to an advertisement hosting service. The transaction component 402 can verify that a user performs in a manner appropriate with earning a reward. For example, the user can be offered a reward for leaving about ten minutes earlier then she initially planned. The transaction component 402 can make a determination if the user left at the designated time and take appropriate action (e.g., if yes, then transfer the reward, but if no, then send a message to the user that she did not meet reward requirements).

A security component 404 can regulate operation of the transaction component 402. Oftentimes, the transaction component 402 can transfer a reward from a banking account of a company to an account of a user. Since this can be considered sensitive information, the security component 404 can protect this transfer through implementation of encryption, password protection, and the like. Moreover, the security component 406 can check financial operations for consistency and perform correction operations. If a wrong amount of money is sent from one party, then the security component 404 can identify an error and send notice that a different amount should be sent.

An interaction component 406 can enable a user to input information to the system 400. The interaction component 406 can obtain a user response to the divulged reward (e.g., gathering of a user's acceptance/denial of a reward offer if a route is provided/followed that includes an alternate route). Commonly, the interaction component 408 can implement as a touch screen, a keyboard, microphone, and the like. While shown as part of the transaction component 402 (e.g., used to enter a pin number), the interaction component 406 can implement as part of the collection component 206 of FIG. 2 to obtain other information types (e.g., an intended destination) as well as function independently and/or in conjunction with other components.

A disclosure component 408 can provide the route to a user (e.g., operating a vehicle passenger or operator, as a pedestrian, etc.) as well as divulge the selected reward to the user. A non-exhaustive list of disclosure components include a display screen, touch screen, speaker system, virtual reality environment, Braille production system, printer, etc. In addition, the disclosure component 408 can present information in multiple formats, such as showing a video with audio capabilities.

Moreover, the disclosure component 408, as well as other components disclosed in the subject specification can implement upon a personal electronic device (e.g., cellular telephone, personal digital assistant, etc.), upon a vehicle (e.g., automobile, motorcycle, bicycle, airplane, helicopter, motorboat, self-balancing transportation device, etc.), etc. According to one embodiment, rewards are provided for different passengers in a vehicle (e.g., a driver of an automobile is given one reward while a passenger of the automobile is given a different reward). For instance, a reward can be provided to a driver and a passenger where if each makes a purchase at a stop along a road, both receive a reward.

A user can accept a reward offer through use of the interaction component 406 and an alteration component 410 can modify a route to avoid the path with the high traffic load when the obtained user response accepts the reward. Oftentimes, the modification takes place upon a route produced by the generation component 208 of FIG. 2. The route can then be presented to the user through utilization of the disclosure component 408. It is to be appreciated that aspects of the subject specification can be practiced without alteration of a route, but through generation of a new route. For instance, a user can be offered the reward prior to creation of the route, where a user response is used in constructing the route.

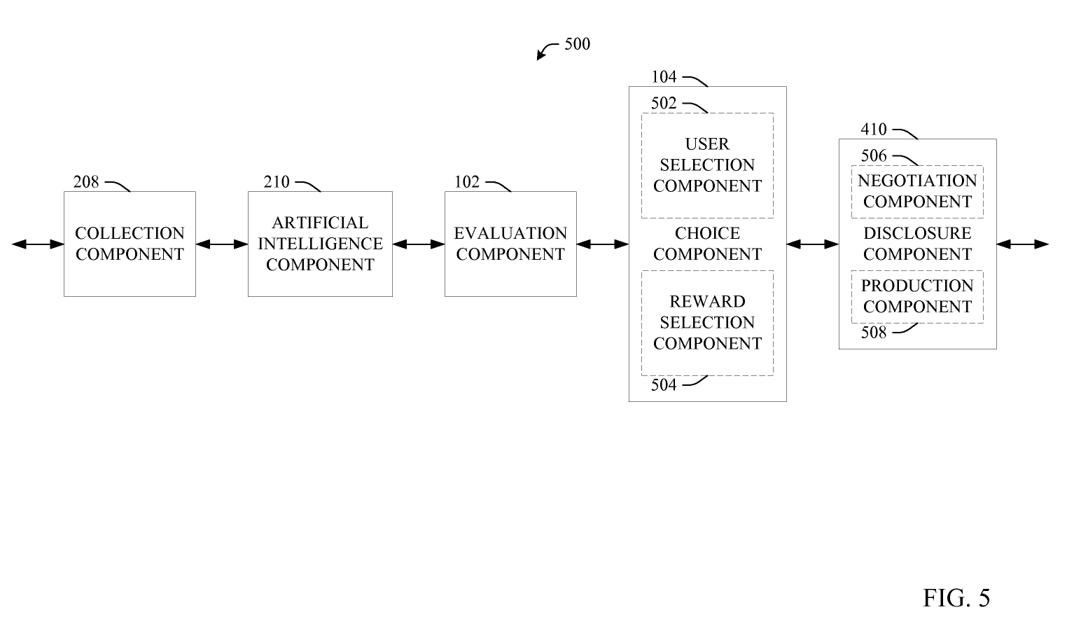

Now referring to FIG. 5, an example system 500 is disclosed for offering a reward to a user for taking an alternate route. A collection component 208 can gather data about a user, traffic patterns, and the like. Data gathering can occur from local storage, remote databases, through communication with a central server, and so forth. The collection component 208 can operate as a means for collecting data that concerns a primary path (e.g., a path with a heavy traffic load that is to be avoided). According to one embodiment, the system 500 can operate upon a central server, where the collection component 208 obtains data from a plurality of vehicles. The system 500 can operate to manage traffic upon a multitude of vehicles/paths.

An artificial intelligence component 210 can analyze data gathered by the collection component 208 and based upon the analysis a determination can be made that a user should be diverted off a path. According to one embodiment, the determination is made between comparing different paths against one another—if one road has heavy congestion while similar roads have lesser congestion, then it can be determined that an offer should be made to a user to take a similar road. The artificial intelligence component 210 can operate as a means for determining that congestion on the primary path is at a level where a user should be offered a reward to take a supplemental path.

The artificial intelligence component 210 can utilize an evaluation component 102 to analyze at least a portion of collected data. The evaluation component 102 can construct a user profile based upon at least a portion of collected information—the profile can be used to determine if a reward is estimated to be sufficient to motivate a user to take an alternate route. For instance, if a user has a history of enjoying scenic automobile drives, then it can be determined the user is likely to accept a diversion to an alternate path that is considered scenic.

A choice component 104 can make various selections in relation to operation of the system 500. A user selection component 502 can choose a user that is presented a reward to take an alternate route. In addition, a reward selection component 504 can choose a reward to motivate a user to take a route—the reward choice can be global (e.g., a general reward applicable to users offered), specific to a user, specific to a class (e.g., adult users are offered one reward while child users are offered another reward), and the like. Analysis of different users can occur and based on the analysis, a user considered highly likely to accept the reward can be selected. According to one embodiment, a plurality of users is offered a reward and a set number/percentage to accept the reward has their routes altered while remaining users have the offer revoked.

The user selection component 502 can operate as a means for selecting a user that is capable of taking the supplemental path. The evaluation component 102 can implement as a means for evaluating the user in view of a reward that is likely to motivate the user to take the supplemental path. Moreover, the reward selection component 504 can function as a means for choosing a reward to offer the user for taking the supplemental path; the reward is specifically tailored to the user based upon a result of the evaluation.

A disclosure component 410 can transmit route and/or reward information to a user's personal electronic device, a vehicle routing system, and so forth. It is possible that a user desires to bargain for a reward and a bargaining process can be facilitated by a negotiation component 506. A company can offer a reward to a user and the user can submit a counter offer—both actions can be facilitated by the negotiation component 506. The negotiation component 506 can implement as a means for negotiating with the user to take the supplemental path based upon the reward.

A user offered a reward can accept the reward and based upon the acceptance a route with a supplemental path can transfer to a user through use of a production component 508. The production component 508 can format a route for a specific situation of a user—if a device a user is expected to use to view the route has a small display screen, then the production component 508 can filter out extraneous information. The production component 508 can operate as a means for producing a route to the user that includes the supplemental path when the user accepts the reward.

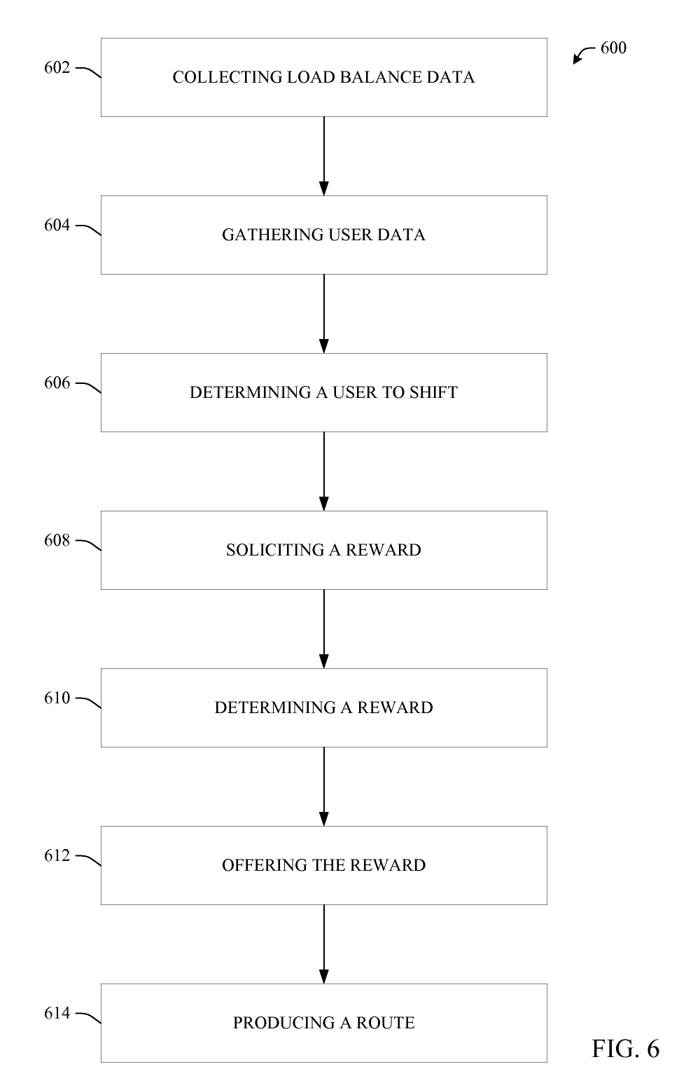

Now referring to FIG. 6, an example methodology 600 is disclosed for managing a traffic load upon a path. Various load balancing data can be collected at action 602. For instance, a company operating the methodology 600 can subscribe to a service that provides real-time traffic information. A connection can be made to the service, where traffic information is constantly supplied to the company. In addition, a police department can monitor load balance information through use of patrol automobiles, helicopters, walking officers, and the like. Action 602 can include collecting load balance data for a path. Proper statistical data can be used to predict what will be the traffic in a next one hour based on a day and time, events calendar, weather, road reconstructions, etc. The data for the future traffic can be used for better estimation of the traffic at a specific moment when the user is anticipated be at a location.

Information concerning at least one user can be gathered at event 604. A government organization can offer citizens the ability to participate in a reward program, where users can be offered rewards to take different routes in order to balance traffic loads. Citizens can agree to submit information that is transferred to the organization that relates to citizen travel plans (e.g., if a user is in a hurry, if a user is comfortable traveling at certain times, and the like).

A user that is to be shifted from a primary route to a supplemental route can be determined through action 606. The government organization can analyze the different users and select users that should be offered rewards to move to an auxiliary route. Comparison of users can take place to determine users that are likely to accept an offer and/or filtering can occur to sort out users that are considered unlikely to accept an offer, automatically. Action 606 can include determining at least one user that is to be offered an opportunity to avoid the path based upon at least a portion of the collected load balance data. While event 604 is shown between actions 602 and 606, it is to be appreciated that actions 602 and 606 can be practiced independent of event 604.

At block 608, a reward to be offered to a user can be solicited. According to one embodiment, different companies are asked to submit reward bids for a user to take an alternate route. However, other implementations can be practiced—for example, a database can be accessed of rewards and user profile data can be compared against available rewards. Example rewards can include money, credit, debt fulfillment, local, state, or federal tax reliefs, coupons, and so forth.

A reward that is to be offered to a user can be determined at action 610. Different rewards can be compared, aggregated, etc. to determine a reward that is highest and/or most beneficial for a user. For instance, a user can be offered a higher coupon value to take one alternate path than a cash value offered to take another alternate path—action 210 can weigh a difference between rewards and select a reward that is estimated to be most beneficial to a user. In another example it can be considered of little value to offer state tax relief to out-of-state users—thus for out-of-state passengers, a state tax relief reward can be listed as unavailable and not used in computation.

The selected reward can be offered to the user at event 612. The determined reward can be presented to a user in addition to an alteration to a route that is associated with the reward. According to one embodiment, the user can be presented with multiple options (e.g., multiple alternate routes with associated rewards) and the user selects at least one presented option.

A route can be produced to a user at act 614, oftentimes upon the user accepting the reward. A user can accept a reward and thus a route is modified to incorporate an associated path. The modified route can be presented to the user and actions of the user can be monitored to determine if the user follows the route. In one configuration, a user is not provided the reward until she completes the alternate path. Moreover, feedback of the user can be gathered, such as the user providing information on if she believes the reward was worth the presumed inconvenience of the alternate route. The feedback can be used to alter a user profile, change operation of the methodology 600, and the like. Act 614 can include producing a route to the user; the route includes a portion that enables the user to earn the reward.

Aspects of the subject specification, including those of FIG. 6, can be practiced through use of a central administrative entity (e.g., a central server). A central dispatcher (e.g., a person, automated processor, etc.) could target a certain level of load balancing and compute an optimized manner in which to achieve the load balancing. Optimized could include that advertisers benefit most, the government benefits most, a largest number of users receives a benefit, and the like. The central dispatcher could compute probability that people will take a route based upon offered rewards and construct contingent scenarios based on different, probable outcomes. As users accept/reject the rewards, the central dispatcher can recompute a situation, taking into account probabilities of acceptance and expectations of benefit.

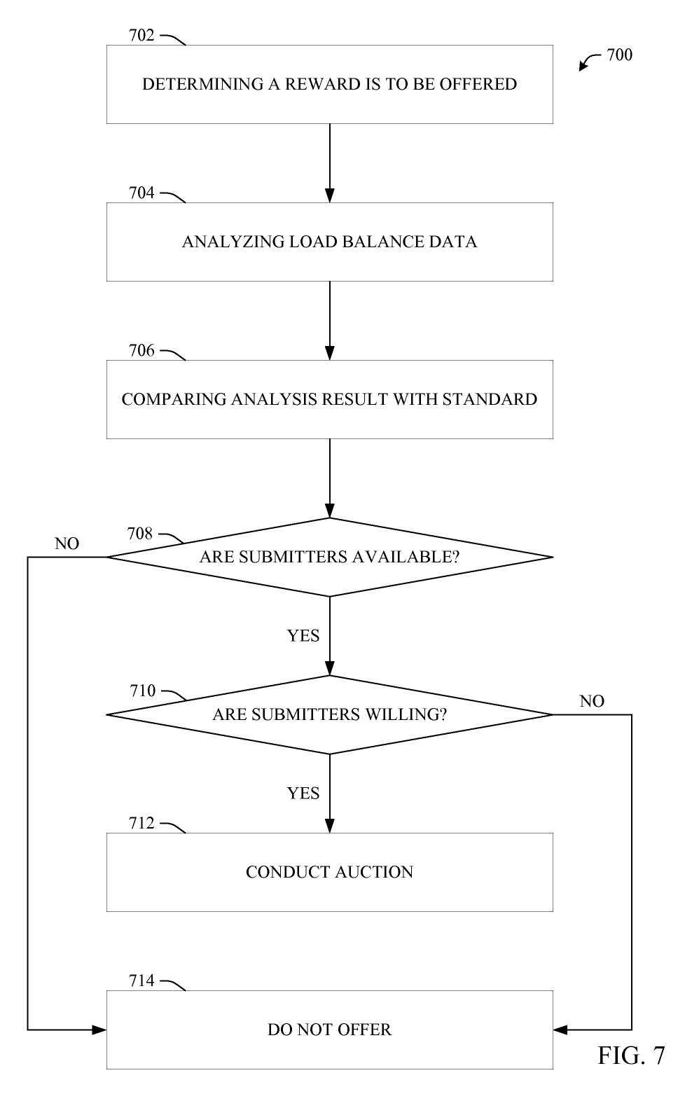

Now referring to FIG. 7, an example methodology 700 is disclosed for conducting an auction to offer a reward to a user to take an alternate route based upon traffic load balancing. A determination can be made as to a reward to be offered at action 702. A government organization can have a pool of money to distribute in order to regulate traffic load and it can be determined that at least a portion of the pool is to be spent to regulate a particular path.

Load balance data for at least one path (e.g., road, sidewalk, shipping lane, airplane route, etc.) can be analyzed at event 704. Different comparisons can be made among different paths to determine paths considered most in need of having load balance problems solved. In addition, various predictions can be made based upon the load balance data, such as when a situation is expected to end that causes the balancing problem. In an illustrative instance, a natural disaster can occur in a major area and load balance data can be used to suggest users to travel upon different conduits. In another example, a major roadwork requiring re-dispatching of traffic to prevent major roadblocks and ensure access of service machines to the repairing site can occur.

A comparison can be made between an analysis result of the load balance data and a balancing standard at act 706. The organization can have an interest in spending more reward to alleviate major load balancing problems than minor problems. Analysis of the load balance data (e.g., real-time information, predictions, etc.) can be used to determine how much reward is to be spent. Different standards can be used to compare a level of load balance problems.

A check 708 can take place to determine if bid submitters are available. A request can go out to various entities allowing the entities to submit reward offers. Based upon a response of potential submitters (e.g., entities offered to make a bid), a check 710 can also take place to determine if available submitters are willing to make a bid. Further checks can take place to aid in functionality, such as determining if a bid submission is reasonable.

If there are available submitters willing to make a bid, then an auction can be conducted at action 712. The auction can be non-public (e.g., bidders supply bids without knowing what is submitted by competitors), public (e.g., full competitor bid disclosure), semi-public (e.g., competitors that bid are known, but not values), etc. If a submitter is not available or a submitter is not willing to make a bid, then an offer does not occur and a standard route can be disclosed to a user at act 714.

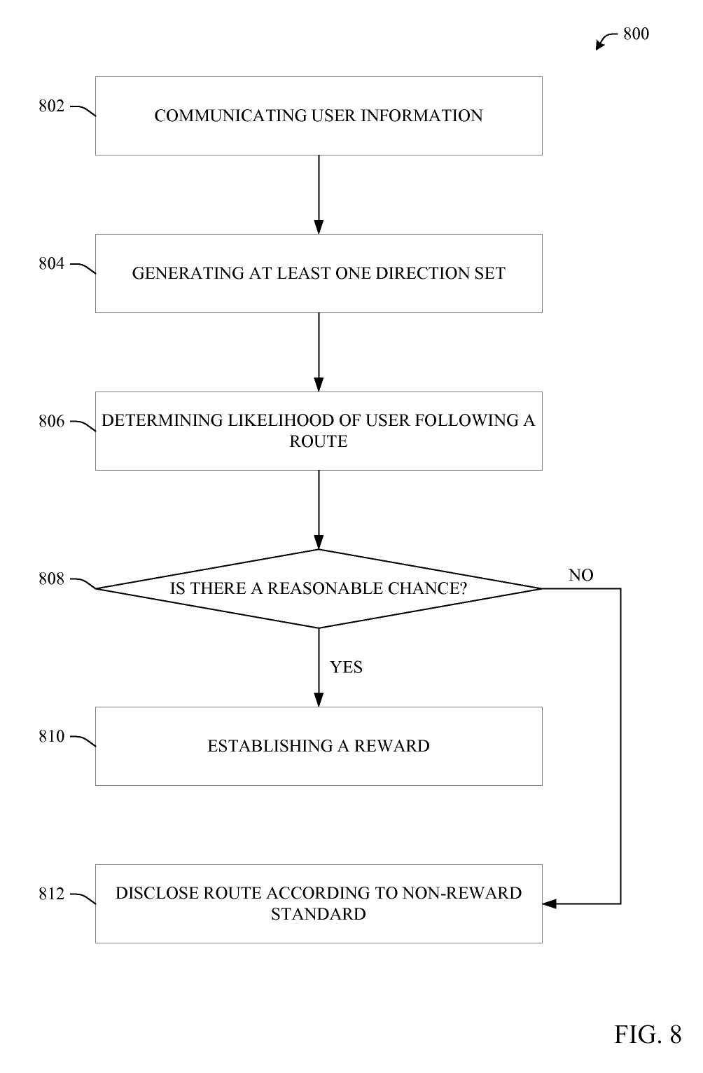

Now referring to FIG. 8, an example methodology 800 establishes probability of a user following an alternate route. User information (e.g., user history, contextual data, and the like) can be communicated at action 802. Example communication includes asking a user for data, extracting information from a profile, making contextual observations, and the like.

A direction set can be generated at act 804; the direction set is commonly based at least in part upon the user information. With the generated direction set, different paths can be analyzed to determine if there is a path that should have users diverted to alleviate load balancing issues. In addition, a check can be performed upon a mapping database to determine potential alternate paths upon which a user can be diverted.

A determination can be made as to how likely a user would be to accept a changed route at event 806. The determinations can be based upon global information as well as on specific user information. For instance, on a Monday morning at 8AM, there can be a high probability people are traveling to work and few users will accept a long diversion. However, if a similar situation occurs on a Sunday at 8AM, a presumption can be that users are likely to accept an offer to change a path. This information can be used to determine how likely a user would be to accept a reward offer.

Check 808 determines if there is a reasonable chance the user will accept the changed route. In a relatively rural area, it can be likely that few alternate routes are available that do not take a user far from an effective route. Based upon various types of information (e.g., user history, contextual data, and the like), the check 808 can make a prediction if there is a reasonable chance the user will want to change his route to alleviate load balancing concerns.

If a reasonable chance exists, then a reward can be established at action 810. Establishment of the reward can take place in a manner discussed throughout the subject specification, such as through operating an auction. However, if a reasonable change does not exist (e.g., it is determined that there is not a reasonable chance), then a standard route is disclosed at event 812. According to one embodiment, a route can be initially generated and if there is a reasonable change, then the generated route can be modified. However, the methodology 800 can also operate such that a route is not generated until a determination is made at check 808 (e.g., individual paths can be analyzed, but a user-specific route is not built until traffic load balancing operations occur).

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

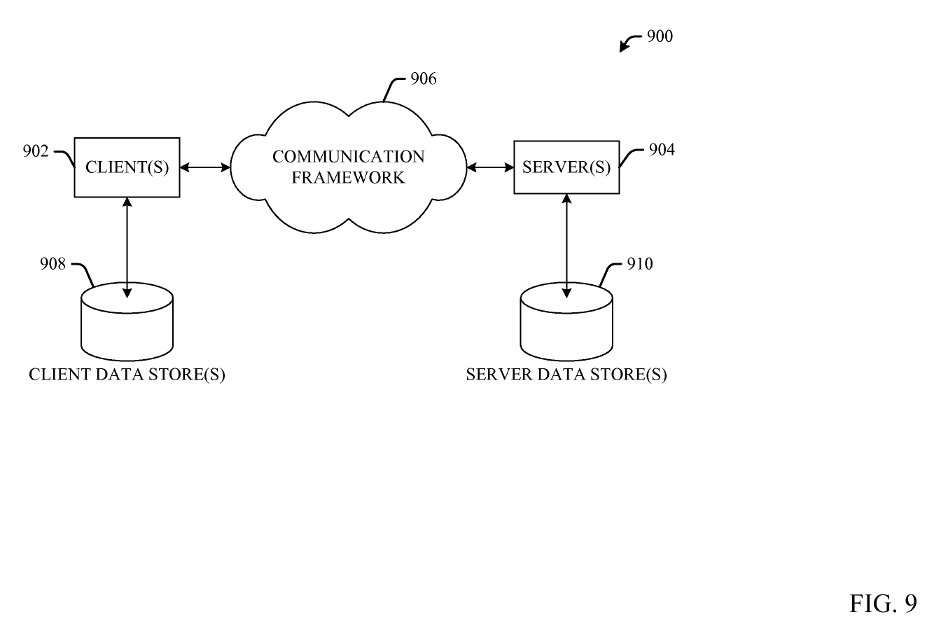

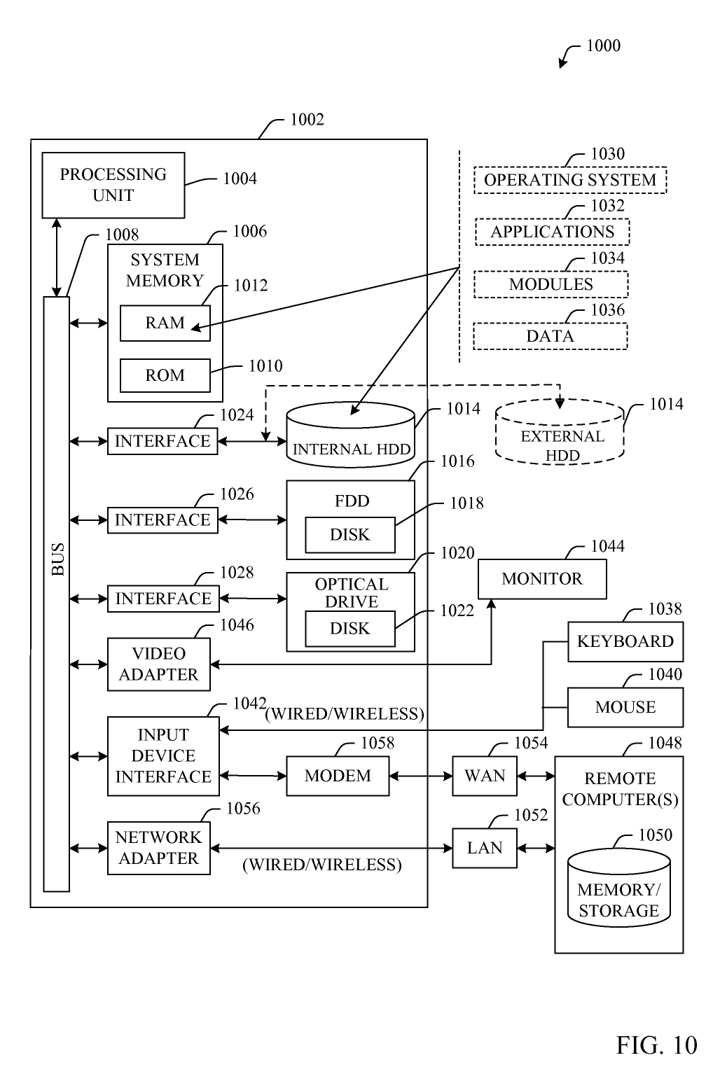

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embody computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors or proprietary specific configured processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various proprietary or commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The aforementioned systems have been described with respect to interaction among several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an evaluation component that analyzes metadata related to a user; and
a choice component that selects a reward to motivate the user to avoid a path with a high traffic load, the selection is based upon a result of the analysis.

2. The system of claim 1, further comprising a recognition component that identifies the path with the high traffic load.

3. The system of claim 1, further comprising a disclosure component that divulges the selected reward to the user.

4. The system of claim 3, further comprising an interaction component that obtains a user response to the divulged reward.

5. The system of claim 4, further comprising an alteration component that modifies a route to avoid the path with the high traffic load when the obtained user response accepts the reward.

6. The system of claim 5, further comprising a generation component that constructs the route that is modified.

7. The system of claim 1, further comprising a transaction component that performs a financial operation in regard to the selected reward.

8. The system of claim 1, further comprising a computation component that calculates the selected reward.

9. The system of claim 1, further comprising a collection component that obtains the metadata related to the user.

10. The system of claim 9, further comprising a search component that locates at least one source of metadata related to the user, the collection component obtains metadata related to the user from at least one located source.

11. The system of claim 1, further comprising an artificial intelligence component that makes at least one determination or at least one inference in regard to the metadata analysis or reward selection.

12. The system of claim 1, further comprising a cooperation component that enters a negotiation with at least one entity, the entity supplies the reward.

13. A method, comprising:
collecting load balance data for a path; and
determining at least one user that is to be offered an opportunity to avoid the path based upon at least a portion of the collected load balance data.

14. The method of claim 13, where the opportunity is a reward.

15. The method of claim 14, further comprising producing a route to the user, the route includes a portion that enables the user to earn the reward.

16. The method of claim 14, further comprising determining the reward to be offered to the user.

17. The method of claim 16, further comprising soliciting reward offers, the determined reward is a function of at least one solicited offer.

18. The method of claim 13, further comprising gathering data concerning at least one user, the gathered data is used in determining at least one user that is offered the opportunity.

19. A system, comprising:
means for collecting data that concerns a primary path;
means for determining that congestion on the primary path is at a level where a user should be offered a reward to take a supplemental path;
means for selecting a user that is capable of taking the supplemental path;
means for evaluating the user in view of a reward that is likely to motivate the user to take the supplemental path;
means for choosing a reward to offer the user for taking the supplemental path, the reward is specifically tailored to the used based upon a result of the evaluation; and
means for negotiating with the user to take the supplemental path based upon the reward.

20. The system of claim 19, further comprising means for producing a route to the user that includes the supplemental path when the user accepts the reward.
